(19) United States
(12) Patent Application Publication
(10) Pub. No.: US 2014/0019545 A1
(43) Pub. Date: Jan. 16, 2014

(54) Social Graph Expanding Method, Program and System

(71) Applicant: International Business Machines Corporation, Armonk, NY (US)

(72) Inventors: Akihiro Kosugi, Tokyo (JP); Shin Saito, Kanagawa (JP)

(21) Appl. No.: 13/937,325

(22) Filed: Jul. 9, 2013

(30) Foreign Application Priority Data
Jul. 11, 2012 (JP) 2012-155217

(51) Int. Cl. H04L 29/06

(52) U.S. Cl. CPC H04L 65/403
USPC 709/204

(57) ABSTRACT

A social graph expanding method, program, and system to expand a social network even when the social network is inadequate and there is no incentive for users to proactively contribute. The system determines the proximity to the target state when new edges are added to a social network and the distance between nodes is reduced by the new edge. To achieve this purpose, the system displays GUI cards to users of a client system connected to a web server, which prompts users to enter information and introduce new edges. The system uses an algorithm including the following priority criteria: an edge (card) related to a person closer to one's node has a higher priority; a larger sum of distances shrunk by the introduction of the edge has a higher priority; and a card with lower operating costs has a higher priority.

### CROSS-REFERENCE TO RELATED APPLICATION

This application claims priority under 35 U.S.C. §119 from Japanese Patent Application No. 2012-155217 filed Jul. 11, 2012, the entire contents of which are incorporated herein by reference.

### BACKGROUND OF THE INVENTION

The invention relates to the field of social network systems (SNS). More specifically, a technique for expanding a social network graph linking individual users and items in a SNS.

Social network systems (SNS) have been introduced to companies to encourage activity across the organization. In order for a SNS to function effectively, a network must be constructed based on data that relates both users and content to each other.

Facebook is an example of an SNS which has an increasing number of users. In these social network systems a certain amount of preference data is collected, the usefulness of the network increases, and positive feedback becomes possible through the proactive efforts of users. When users do not actively participate in the SNS, data is not collected and the networks do not become useful. This causes users to participate even less, creating a vicious cycle known as the cold start problem. The following literature discloses related technologies for addressing this problem.

Japanese Patent Application No. 2011-227892 describes a system which includes the steps of: creating a specific profile for each user of a social network by supplying data to a context-aware framework using monitor agents in the user's social network; creating a context-aware keyword list rich with content for characterizing the relationships between users in the social network by extracting common interests and related keywords to cluster the original data; and providing an interface for querying the list.

Japanese Patent Application No. 2011-170471 describes a system that includes a social graph generating device, a tag evaluation value determining unit, and a social graph generating unit. In this system, when the social graph generating device receives evaluation request information from an evaluated user, the tag evaluation value determining unit selects a plurality of evaluating users requesting an evaluation value setting related to attribute information on the evaluated user. When tag evaluation information in which an evaluation value has been set by each selected evaluating user has been received, the tag evaluation value determining unit determines whether each evaluating user is a bona fide user or a malicious user using trust. When the number of bona fide users outnumbers malicious users, an evaluation value is determined for the evaluated user. Next, the social graph generating unit extracts the users strongly related to the evaluated user and generates a social graph by executing collaborative filtering using attribute information set by the evaluated user and the evaluation values for this attribute information.

Japanese Translation of PCT Application No. 2009-505286 describes a method for associating public tags, memos, or some other data as annotations to acquaintances in a social network. Here, a means is provided which allows users of a social network to obtain at a glance useful information related to others in the network with whom they have no connection and select acquaintances in the network using keywords defined by the user. This makes it easy for users to discover potential new friends and acquaintances at work.

Japanese Translation of PCT Application No. 2010-500648 describes a method for displaying news in a social network environment which includes the steps of: restricting access to news items to a predetermined set of viewers; generating news items related to activities related to users of the social network environment similar to assigning an order to news items; and connecting an information link related to at least one activity to at least one news item.

Japanese Translation of PCT Application No. 2008-539528 describes a method for scoring the compatibility of members in a social network which includes the steps of: generating an interest compatibility score based on interests provided by members of the social network; and calculating the compatibility score for a first member of the social network and the second member of the social network based on the interests provided by the first member, the interests provided by the second member, and the interest compatibility score between the interests provided by the first member and the interests provided by the second member.

Japanese Translation of PCT Application No. 2010-500649 describes a system for generating content based on personalized dynamic relationships between members of a web-based social network. At least one action of at least one member of a web-based social network is associated with relationship data for one or more members to generate integrated data, one or more elements associated with the integrated data are identified, the integrated data is collected, and the collected integrated data is weighted by affinity in order to generate content based on personalized dynamic relationships between members of a web-based social network.

MATSUO et al., “Social Network Extraction From Web Information”, Journal of the Japanese Society for Artificial Intelligence, 2005, describes a method for extracting the strength of a relationship between individuals from the co-occurrence of their names in documents on the web (search results from a search engine). This method is premised on a large number of documents having a co-occurrence.

TOMOBE et al., “Extraction and Utilization of Human Social Network For the Semantic Web”, Journal of the Information Processing Society of Japan, 2005, describes a technique similar to that of MATSUO et al.

BIRD et al., “Mining Email Social Networks”, MSR, 2006, describes a method for extracting and analyzing relationships from groups of addresses appearing in email. Here, “betweenness” is defined as the indicator for detecting important people.

DAS et al., “Google News Personalization: Scalable Online Collaborative Filtering”, WWW, 2007, describes the collaborative filtering used by Google News.

Kamishima, “Algorithms for Recommender Systems (1)-(3)”, Journal of the Japanese Society for Artificial Intelligence, 2007-2008, are a series of introductory articles on recommender systems. These articles describe a weakness of recommender systems, which is that valid results are difficult to obtain unless a certain number of user preferences has been collected.

AMITAY et al., “Social Search and Discovery Using a Unified Framework”, Hypertext, 2009, describes item searching and scoring in an SNS.

The techniques described in the related art allow one to take full advantage of a social network that already exists and is fully activated. In addition, the related art describe techniques which construct social networks based on a user's own information and based on the user's history of past activity. However, a social network cannot be constructed in an environment in which the social network is inadequate and the users are not active. Therefore, the purpose of the present invention is to provide a technique able to expand a social network, even when the social network is inadequate and there is no incentive for users to proactively contribute to the social network.

### SUMMARY OF THE INVENTION

Accordingly, one aspect of the present invention is a computer implemented method for expanding a social graph, wherein the computer includes a processor communicatively coupled to a memory, the method including the steps of: preparing a plurality of questions for adding to the social graph an edge E1 or an edge E1 and a node N1 at an endpoint of the edge; determining a predetermined number of questions among the plurality of prepared questions to present to a user indicated by given node N2 representing a user in the social graph; and the determination step including a step performed based on at least one item among operating costs for an operation in an answer to a question, the distance between node N2 and node N3 at one endpoint of the added edge E1, and the sum of the inter-nodal distances reduced by the addition of edge E1 across some or all of the nodes in the social graph.

Another aspect of the present invention is a computer readable storage medium tangibly embodying a computer readable non-transitory program code having computer readable instructions which, when implemented, cause a computer to carry out the steps of a method for expanding a social graph, the method including the steps of: preparing a plurality of questions for adding to the social graph an edge E1 or an edge E1 and a node N1 at an endpoint of the edge; determining a predetermined number of questions among the plurality of prepared questions to present to a user indicated by given node N2 representing a user in the social graph; and the determination step including a step performed based on at least one item among operating costs for an operation in an answer to a question, the distance between node N2 and node N3 at one endpoint of the added edge E1, and the sum of the inter-nodal distances reduced by the addition of edge E1 across some or all of the nodes in the social graph.

Another aspect of the present invention is a computer system for expanding a social graph, including: means for preparing a plurality of questions for adding to the social graph an edge E1, or an edge E1 and a node N1 at an endpoint of the edge; means for determining a predetermined number of questions among the plurality of prepared questions to present to a user indicated by given node N2 representing a user in the social graph; and the means for determining including means performed based on at least one item among operating costs for an operation in an answer to a question, the distance between node N2 and node N3 at one endpoint of the added edge E1, and the sum of the inter-nodal distances reduced by the addition of edge E1 across some or all of the nodes in the social graph.

### BRIEF DESCRIPTION OF THE DRAWINGS

FIG. 1 is a schematic diagram of a hardware configuration according to an embodiment of the present invention.

FIG. 2 is a block diagram of a hardware configuration for a client computer according to an embodiment of the present invention.

FIG. 3 is a block diagram of a hardware configuration for a web server according to an embodiment of the present invention.

FIG. 4 is a block diagram of a functional configuration according to an embodiment of the present invention.

FIG. 5 is a flowchart of the processing performed according to an embodiment of the present invention.

FIG. 6 is a diagram schematically illustrating an example of a social network graph according to an embodiment of the present invention.

FIG. 7 is a diagram showing the expansion of a social network graph according to an embodiment of the present invention.

FIG. 8 is a diagram showing a priority calculation algorithm an embodiment of the present invention.

FIG. 9 is a diagram showing an example of a card in a web browser according to an embodiment of the present invention.

FIGS. 10(a)-(c) are diagrams showing an example of a card presented to a user according to an embodiment of the present invention.

FIGS. 11(a)-14(b) are diagrams showing examples of a card presented to a user according to an embodiment of the present invention.

### DETAILED DESCRIPTION OF THE PREFERRED EMBODIMENTS

The following is an explanation of examples of the present invention with reference to the drawings. These examples are provided to explain preferred embodiments of the present invention. However, the scope of the present invention is not limited to the examples shown here. In the drawings, the same objects are denoted by the same reference symbols unless otherwise indicated.

The purpose of the present invention is to provide a technique that is able to expand a social network even when the social network is inadequate and there is no incentive for users to proactively contribute to the social network. The present invention provides a system which achieves this by creating a minimal social network with a hierarchical structure and by adding nodes and edges reflecting relationships between actual users and items to expand the social network. In other words, the system of the present invention determines the proximity to the target state when new edges are added to a social network and the distance between nodes is reduced by the new edge.

In a preferred embodiment, the system of the present invention displays GUI cards to users of a client system connected to a web server which prompt users to enter information and introduce new edges. The system of the present invention uses an algorithm comprising the following priority criteria to select cards to be displayed:
(1) An edge (card) related to a person closer to one's node has a higher priority.
(2) A greater sum of distances shrunk by the introduction of the edge has a higher priority.
(3) A card with lower operating costs has a higher priority.
   One or all of the three criteria can be used.

In other words, the present invention can effectively expand a social network by selecting cards that relate to nodes in accordance with priority criteria and displaying the cards as GUI to prompt users of the system to enter information and by introducing edges based on entered responses.

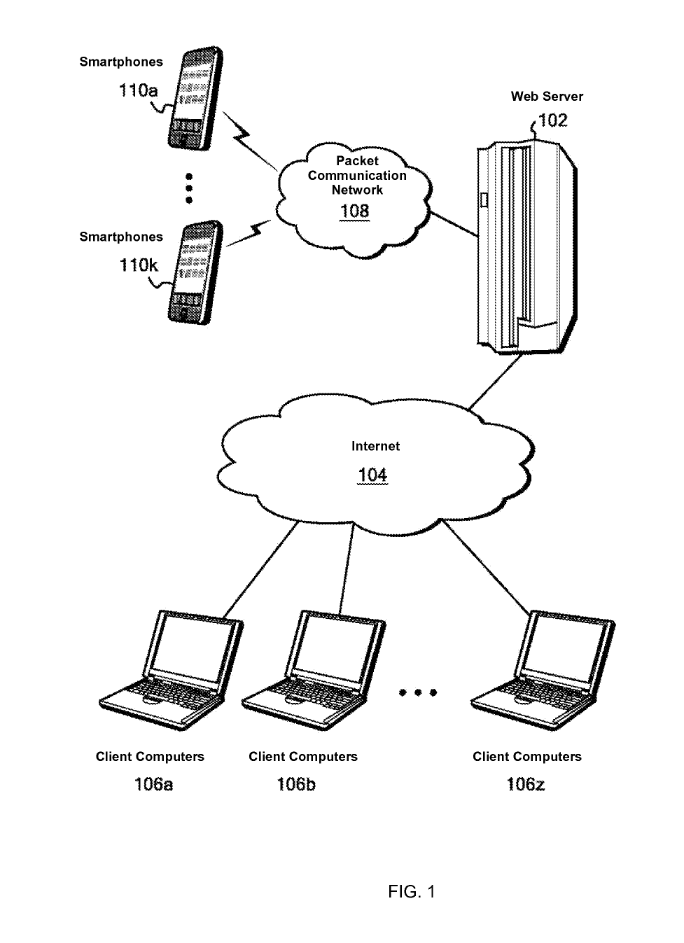

In FIG. 1, a plurality of client computers 106a, 106b, . . . 106z are connected to a web server 102 via the internet 104. In the system of FIG. 1, the user of a client computer logs into web server 102 via a web browser and the internet 104. More specifically, a URL is typed into the web browser and a predetermined page is displayed. Here, the service realized by the web server 102 is a social network system (SNS).

In order to log in, the user of the client computer enters a user ID and password associated with the user ID. Once the user of the client computer has logged into the SNS, a blog entry can be written, the blog entries of other people with access to the system can be read and commented upon, news can be read, groups can be formed with likeminded people, chat sessions can be held, and likeminded communities can be discovered. Mobile terminals such as smartphones 110a, . . . 110k are connected to the web server 102 via a packet communication network 108. If users remember their user ID and password, they can access the SNS of the web server 102 using the web browser installed in their smartphone.

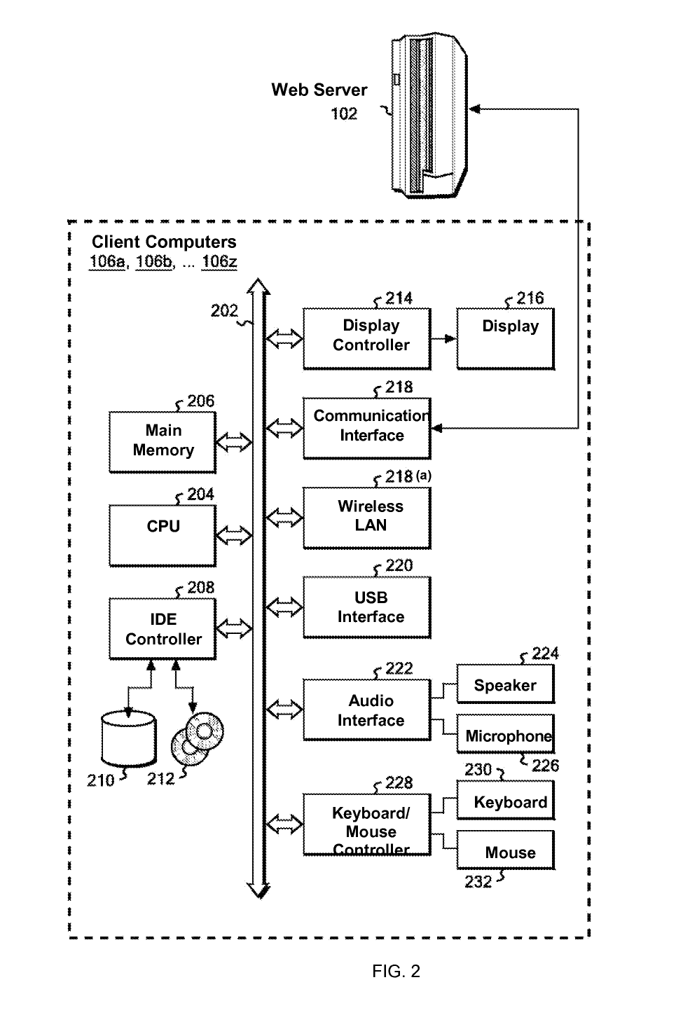

Referring to FIG. 2, the following is an explanation of the hardware blocks of the client computer indicated by reference numbers 106a, 106b . . . 106z in FIG. 1. In FIG. 2, the client computer is typically a personal computer with a main memory 206, CPU 204, and IDE controller 208 connected to a bus 202. Also connected to the bus 202 are a display controller 214, communication interface 218 [which can include a wireless LAN 218(a)], USB interface 220, audio interface 222, and keyboard/mouse controller 228. The IDE controller 208 is connected to a hard disk drive (HDD) 210 and a DVD drive 212. The DVD drive 212 is used to introduce the program from a CD-ROM or DVD if necessary. The display controller 214 is preferably connected to a display device 216 with an LCD screen. SNS screens are displayed on the display device 216 using a web browser. If necessary, the USB interface 220 can be connected to devices such as a dedicated controller. These devices can be used to make the SNS easier to use.

The keyboard/mouse controller 228 is connected to a keyboard 230 and a mouse 232. The keyboard 230 is typically used to write chat messages and enter community information to be searched in the SNS. The mouse 232 is used to click links, read news, select operations from menus, and select blogs to read in the SNS. The CPU 204 can have a 32-bit architecture or 64-bit architecture. Examples include Pentium 4 (trademark of Intel Corporation) or Core (trademark) 2 Duo from Intel Corporation or Athlon (trademark) from Advanced Micro Devices. The audio interface 222 can be connected to a speaker 224 and a microphone 226. The speaker 224 is provides auditory feedback to a user. The microphone 226 transmits user audio to the audio interface 222.

The hard disk drive 210 includes at least an operating system and a web browser (not shown) that operates on the operating system. The operating system is loaded into the main memory 206 at system startup. Operating systems that can be used include Windows XP (trademark of Microsoft Corporation), Windows (trademark of Microsoft Corporation) 7, Linux (trademark of Linus Torvalds), and Mac OS X.

Programs for embodying the functions of the present invention on the client side are introduced to the hard disk drive 210. These programs can be introduced in the form of a plug-in for the web browser and downloaded beforehand from a web server 102. The plug-in is operated by JavaScript® and calls up RESTAPI on the web server 102 side. Therefore, in this example, the web browser supports JavaScript®. However, the present invention is not limited to this. Internet Explorer, Firefox and Google Chrome can also be used. JavaScript® operability is not essential. Any program that can communicate based on HTTP protocol to call up RESTAPI can be used. In the case of a Smartphone, a native application can be installed to initiate HTTP protocol communication. The communication interface 218 uses the TCP/IP communication function provided by the operating system and communication with the web server 102 is conducted via Ethernet (trademark) protocol (not pictured), wireless LAN 218(a), and the like.

The configuration of the client computers 106a, 106b, . . . 106z was described above. Because the configuration of the smartphones 110a, . . . , 110k is nearly identical to the configuration of the client computers 106a, 106b, . . . , 106z in the context of this example, further description has been omitted. Preferably, the web browser in the smartphones 110a, . . . , 110k also has an introduced plug-in operated by JavaScript® and calling up RESTAPI on the web server 102 side.

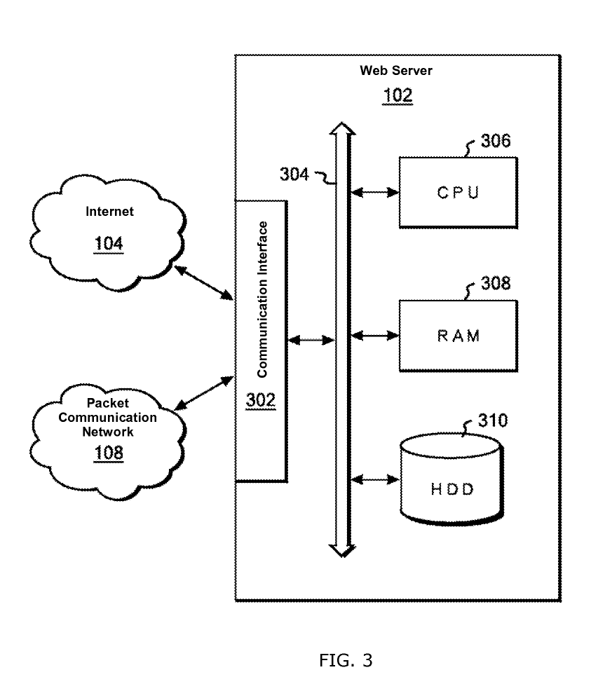

FIG. 3 is a simplified block diagram of the hardware configuration on the SNS side. As shown in FIG. 3, the internet 104 used to communicate with client computers and a packet communication network 108 used to communicate with smartphones are connected to the communication interface 302 of the web server 102. The communication interface 302 is also connected to a bus 304. The bus 304 is connected to the CPU 306, the main memory (RAM) 308, and the hard disk drive (HDD) 310. While not shown in the drawings, web server 102 may also be connected to a keyboard, mouse, and display to manage and maintain web server 102.

The hard disk drive 310 in the web server 102 stores an operating system and a correspondence table of user IDs and passwords used to manage the log-in of client computers 106a, 106b, . . . , 106z. The hard disk drive 310 also stores software, such as Apache, enabling the web server 102 to function as a web server. This is loaded into the main memory 308 and activated when the web server 102 starts up. This enables the client computers 106a, 106b, . . . , 106z to access the web server 102 using the TCP/IP protocol. While not shown in the drawings, the hard disk drive 310 in the web server 102 also stores a communication module used to communicate with smartphones via the packet communication network 108.

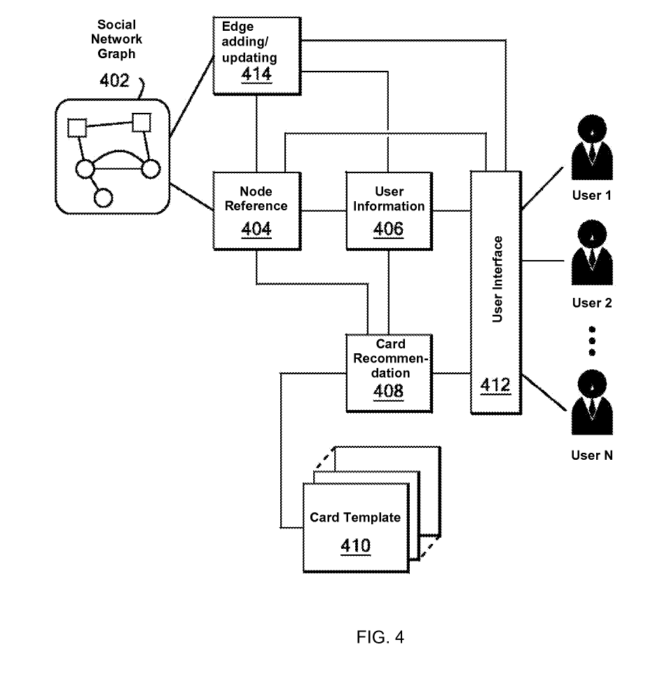

The hard disk drive 310 in the web server 102 also stores information such as the messages, blogs, and bulletin boards of each user of the SNS. The SNS information is preferably stored in text format, such as in HTML files, or multimedia formats, such as graphic images, video files, and audio files. Users can write entries in their blogs or bulletin boards and other users can read these blogs and bulletin boards and post comments if authorized. The hard disk drive 310 also stores social network graphs (SNS graphs) 402. SNS graphs 402 are explained below with reference to the function block diagram in FIG. 4, the node reference routine 404, user information files 406 on members of the SNS including profile information (such as IDs, interests and preferences), the card recommendation routine 408, the user interface module 412 and the edge adding/updating routine 414.

The web server 102 can be any type of server, such as an IBM (trademark of International Business Machines Corporation) System X, System i, or System p server available from International Business Machines Corporation. Available operating systems include AIX (trademark of International Business Machines Corporation), UNIX (trademark of The Open Group), Linux (trademark of Linus Torvalds), and Windows (trademark) 2003 Server. The operating system in this example is Linux (trademark of Linus Torvalds) to which Java® EE has been introduced. Server-side Java® has been introduced and the node reference routine 404, the card recommendation routine 408, and the edge adding/updating routine 414, which are processing programs of the present invention, are preferably installed as Java® programs or Servlet.

The following is an explanation of the processing elements according to an embodiment of the present invention with reference to the function block diagram in FIG. 4. In FIG. 4, the social network graph (SNS graph) 402 is a graph representing the relationship between the target user and items. This can be constructed using the technique described in Japanese Patent Application No. 2011-170471. The creation of a social network graph itself is not a part of the present invention so a detailed description has been omitted.

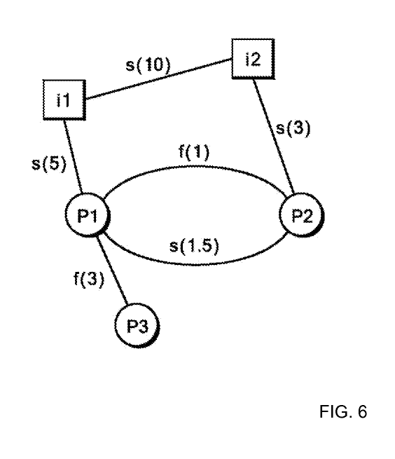

In FIGS. 6, P1, P2 and P3 are people and i1 and i2 are items other than people (such as tags, copyrighted material and blog posts). P1, P2, P3, i1, and i2 are called entities. There are a number of edge types between entities. In this example, t={s, f} where f is familiarity. In other words, this represents a relationship in which the people know each other directly. For example, in an organization it may be a superior and subordinate relationship. Here, s is similarity. In other words, it may be a relationship such as joint authorship, a comment in a blog post, or a tag that has been assigned. A determination is also made as to whether an edge type between nodes is permissible. There is at most one edge of the same type between two nodes and the length of the edge represents the strength of the relationship. A stronger relationship has a shorter length. These are merely examples of possible relationships. Any type of relationship can be used in the present invention. The number, such as 4 in f(4), represents the inverse of the degree of association. In other words, a higher number indicates a longer distance. This distance between nodes N1 and N2 is the length of the shortest path d(N1, N2). For example, in FIG. 6, d(i1, P2)=6.

Returning to FIG. 4, the node reference routine 404 references a node in the social network graph 402 corresponding to the client (user) making a card request. In this example a client computer, or user terminal such as a Smartphone, works with the installed plug-in to send a card request to the web server 102 in response to a user operation on the user terminal and automatically sends the next card request to the web server 102 when there is no card request over a given period of time. Cards and card requests are described below. Usually, the client requests a single card per request. However, multiple cards can also be requested.

User information 406 is stored, including each registered user ID, organizations, interests, and other information. Tag information is also stored as user information 406 when the users use a card to tag themselves or other users. The card recommendation routine 408 generates a card from a card template 410 based on the information from the node reference routine 404 and user information 406, and presents one or more cards to the requester of the cards according to priority. The following is an example of a method used to create candidate cards.

Candidates for cards to be presented to a given user are created in the following manner. The node representing the person in the social network corresponding to the user is denoted as N and a node representing another person is denoted as N1. Item node I, I1, . . . , In denotes all nodes other than person nodes. In other words, these include tag nodes. It is said that “N1 is closer to N in the social network” when d(N1, N) is smaller than others. The following A1-C2 are examples of card templates:
A1. A card in which N is prompted to enter a tag using free text (high cost, distance 0).
A2. A card in which N is prompted to revise or delete tags applied to N by other users (medium cost, distance 0).
A3. A card in which a tag applied to a user near N in the social network is presented, and N is prompted to accept or to accept with revision as a tag for N (medium cost).
A4. A card in which a concern or evaluation is entered using text with respect to node I representing an item linked to a user near N in the social network (high cost).
B1. A card in which a person to which a certain tag applies is entered or selected from among applicable candidates. At this time, a tag representing a node near N is given precedence in the selection process using a prioritizing algorithm (low cost).
Z. A card in which “N” in A1-A3 and B1 has been replaced with “user N1 near N in the social network”. In other words, it is a card in which information related to a third person is entered or edited. Preferably, a card related to user N1 with a few applied tags is given precedence in the creation process (medium cost).
B2. A card in which the strength of the relationship has been entered for a plurality of item nodes I1, I2, . . . In (for example, tag clustering). More specifically, this includes a collection of tag nodes connected to a given person node N1 and a collection of tag nodes close to each other in the social network (medium cost).
B3. A card in which a tag is added to an item node I1 (medium cost).
C1. A card in which an entry is added indicating whether or not a user knows user N1 who is close to N in the social network (medium cost).
C2. A card in which an entry is added indicating the degree to which a user knows user N1 who is close to N in the social network (medium cost).
   A single card can also be created combining a plurality of cards A1-C2. Here, “distance 0” indicates a user's own node.

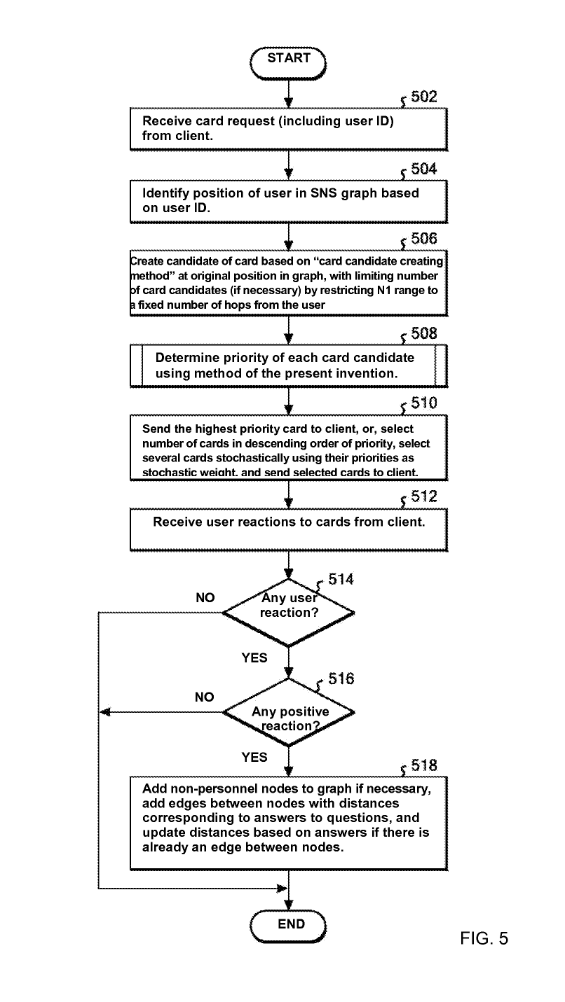

The card recommendation algorithm is explained below in greater detail with reference to the flowchart in FIG. 5. In the card recommendation algorithm, high, middle and low cost are represented by specific numbers. The types of costs can be more finely divided. The user interface module 412 functions to send information related to one or more cards recommended by the card recommendation routine 408 to a user terminal via the network and to receive data entered into a card by a user operation. The edge adding/updating routine 414 adds or updates edges corresponding to a social network graph 402 in accordance with user responses received from the user interface module 412. The processing performed by the edge adding/updating routine 414 is explained in greater detail below with reference to the flowchart in FIG. 5.

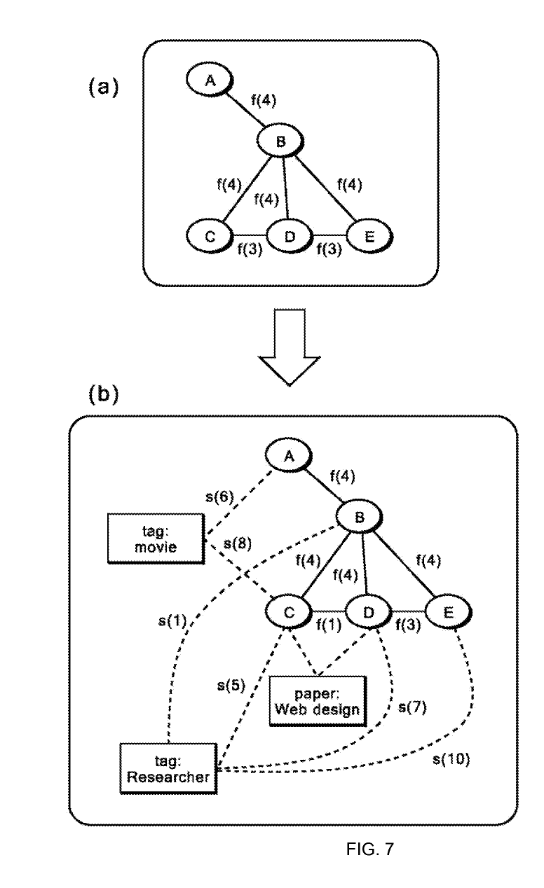

The following is an explanation of the operations performed by this example with reference to the flowchart in FIG. 5. In the present invention, all users are first included as nodes and, as shown in FIG. 7 (a), the process starts from an initial social network graph in which edges are expanded between at least some of the users. In the case of a company or similar organization, this initial social network graph is created in accordance with an organizational chart. If there is no such chart, but personal information is available, names and organizational titles can be obtained to create an initial social network graph. If this is difficult, cards (questions) can be issued directly to new users. If this too is difficult, cards (questions) can be issued randomly to users.

After an initial social network graph has been prepared as the social network graph 402 in Step 502, the user interface module 412 receives a user ID and a card inquiry from a user. A card request can be triggered by a user operation performed on a user terminal or can be triggered automatically and periodically by a plug-in operation performed by the user terminal. In response to this in Step 504, the node reference routine 404 specifies the position (node) of the social network graph (SNS graph) 402 based on the user ID.

In Step 506, a card candidate is created based on the position in the graph and on the method for creating card candidates. Preferably, all cards listed in the method for creating card candidates are generated. In the following example, a card to be issued to N2 is selected. At this time, the number of card candidates may be limited, such as limiting the N1 range to a set number of hops from the user. The number of hops is a number to which 1 is added every time an edge in the graph has been traversed.

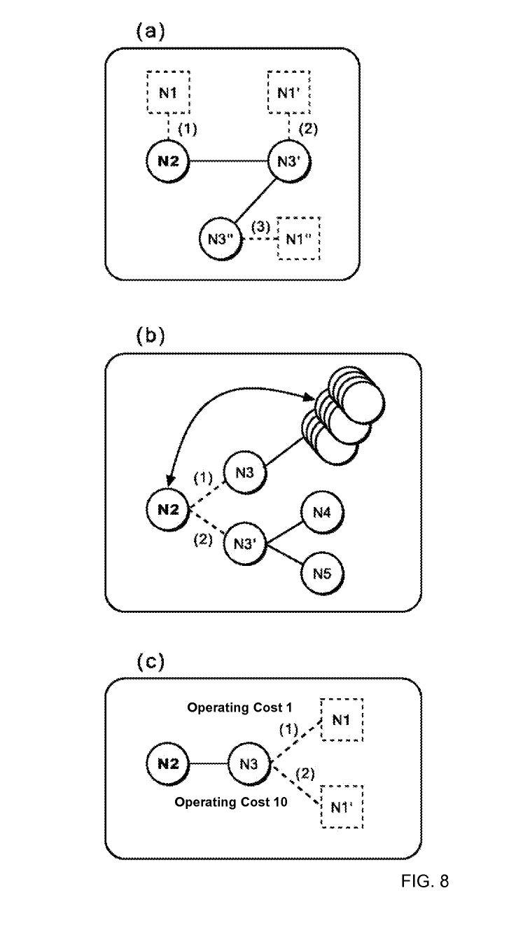

In FIG. 8 (a), an edge (card) related to a person (node) closer to the user has a higher priority. In FIG. 8 (b), a greater sum of the distances shrunk by the introduction of an edge has a higher priority. In FIG. 8 (c), a card with a lower operational cost has a higher priority.

Here, the distance used is the shortest path connecting two nodes. This distance is usually the sum of the distances of traversed edges. However, the distance may be weighted exponentially in the following manner. In other words, when the distances of the edges along a path from node A are d1, d2, d3, etc. in ascending order, the appropriate positive constant a is used to obtain path distance d1+d2*exp(a)+d3*exp(2a)+etc.

In Step 506, the card recommendation routine 408 gives each card a priority. The priorities used at this time are any of those shown in FIG. 8 (a), FIG. 8 (b), and FIG. 8 (c). In Step 508, the card recommendation routine 408 may calculate the priority using one of the three criteria, two of the three criteria, or all three of the criteria in FIG. 8. For example, the priority can be calculated using all three criteria (total sum of distances shrunk by edge introduction)/[(distance of N2 and N3+1)*(operating cost)]. When two criteria are used, any one of the terms in the equation described above can be set as “1” in the priority calculation. In another priority calculating method using a plurality of criteria, priority 1 is assigned to each generated card using one criterion, priority 2 is assigned to each generated card using another criterion, and a determination is made using a priority calculated by adding priority 1 and priority 2 together. All three criteria can be used in a similar manner.

In Step 510, the card recommendation routine 408 returns the card with the highest priority to the client, returns a plurality of cards requested by the client in ascending order of priority, or selects a plurality of cards with a high priority, stochastically weights them by priority, and returns one or more cards requested by the client to the user via the user interface module 412.

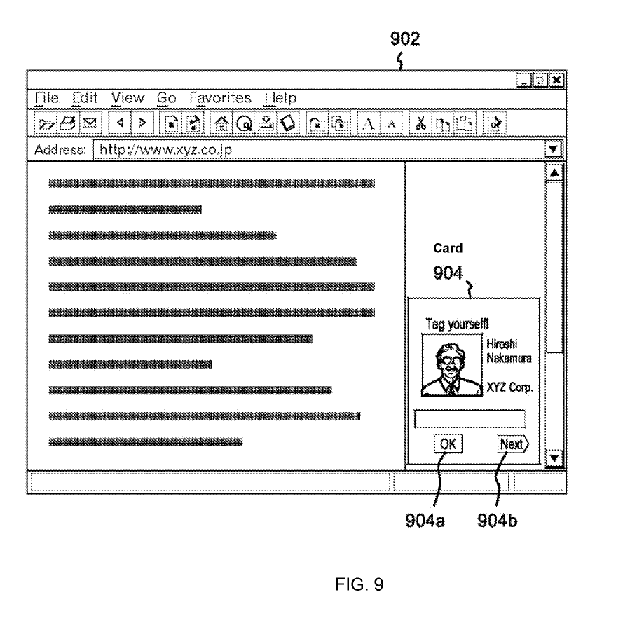

In Step 512, the user terminal displays a card on the screen and a response is received from the user regarding the card. FIG. 9 shows an example in which a card 904 received from the card recommendation routine 408 has been displayed in a web browser on the screen 902 of the user terminal. Preferably, a plug-in has been installed into the web browser for calling up JavaScript® in the client computer or Smartphone user terminal and the plug-in function displays the card 904 in a corner of the web browser screen 902.

If the user has not responded during a predetermined period of time after the card 904 has been displayed by entering something in the card 904 or clicking button 904a or 904b, the decision in Step 514 is NO and the process is ended. When the user has performed an operation with respect to the card 904, the process advances to Step 516. If the user clicks the “Next” button 904b or clicks the “No” button when asked if he or she knows the person on the card, the decision in Step 516 is NO and the process is ended. If the user clicks the “OK” button 904a, the decision in Step 516 is YES and response data is transmitted to the edge adding/updating routine 414 via the user interface module 412. The response data includes information such as one or more tags entered by the user.

In Step 518, the edge adding/updating routine 414 adds new non-person nodes to the social network graph 402 if necessary based on the data received via the user interface module 412 and the current position in the social network graph and adds an edge between two nodes with a distance corresponding to the answer to the question on card 904. If an edge already exists between the nodes, the distance is updated in accordance with the answer.

As the processing is repeated, the initial social network graph shown in FIG. 7 (a) develops into the richer social network graph shown in FIG. 7 (b), which is expanded to include more non-person nodes and edges with shorter distances.

The following are some examples of cards that are presented. One pattern is to have the user attach tags himself/herself.
To acquire a collection of tags applied to the user.
   1. To acquire tags related to job categories.
   2. To acquire tags related to skill areas.
   3. To acquire tags related to business excluding 1 and 2.
   4. To acquire tags related to interests and private information.
   5. To acquire (or estimate using some other method) information related to 1 through 3 about a user where it does not exist from those closest in terms of familiarity distance.
      If tags can be acquired on job categories, skill areas, and other business-related information using these methods, these are presented to the user on cards so the user can correct mistakes. If this information cannot be acquired, cards can be constructed to enter this information using free text.

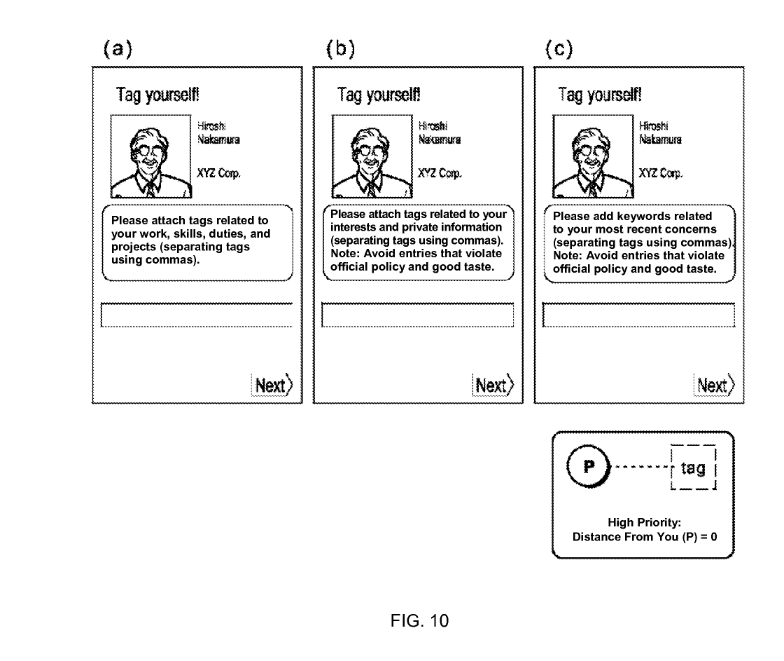

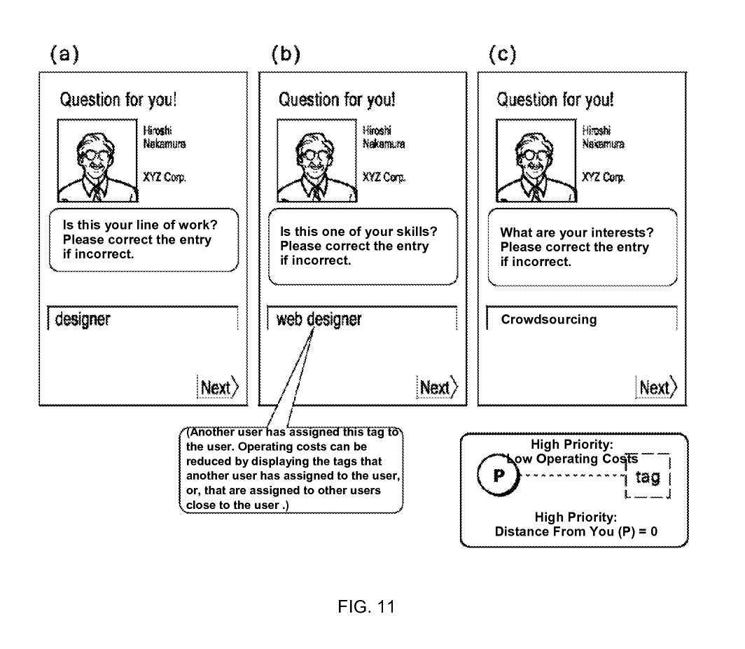

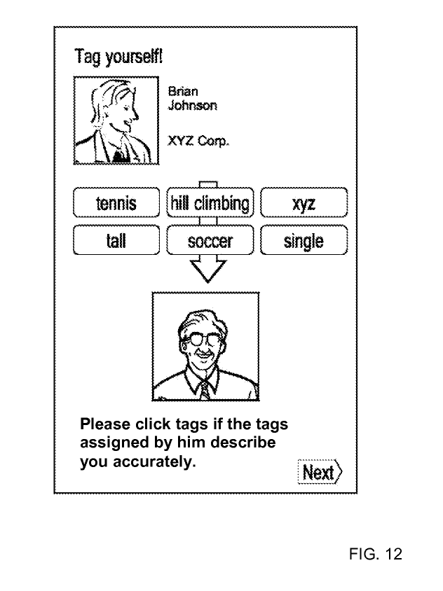

FIG. 10 shows examples of these cards. FIG. 10 (a), FIG. 10 (b), and FIG. 10 (c) show different cards. Each of these cards can be displayed by clicking the “Next >” button. FIG. 11 shows cards presented to the user himself/herself, including items entered by other people or collected automatically. These cards prompt the user to correct any mistakes. Tags entered by the user himself/herself are stored in the web server 102 as user information 406. When each person has entered and stored tags in advance, Brian Johnson can be asked how closely the tags match Hiroshi Nakamura as shown in the card in FIG. 12. How closely tags match a person can be used to calculate the similarity between two users as shown in FIG. 6.

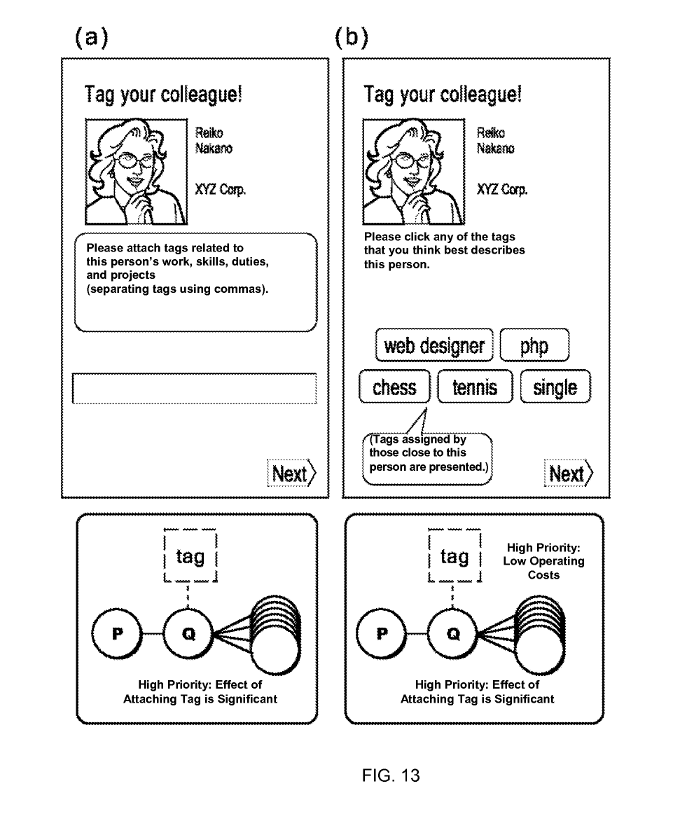

Another pattern is to have others (acquaintances) attach tags. Here, a person close to the user in terms of familiarity distance who hardly has any tags is selected (Q). Preferably, Q is an influential person linked to many nodes in the graph. The following are examples of such cards.
Cards in which tags about Q are entered using free text.
Cards in which tags collected from persons close to Q or keywords extracted using natural language processing that best describe Q are selected.
Random tags may be presented on purpose in order encourage the active participation of users.
   FIG. 13 shows examples of these cards.

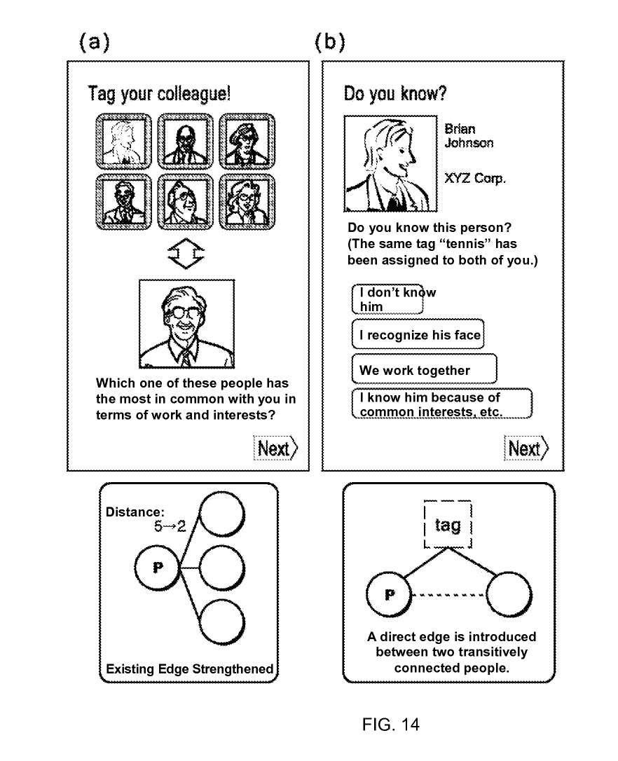

Another pattern is to strengthen existing edges.
To acquire person(s) who are close in familiarity distance to a user and who know the user well.
   Cards in which those closest to a user are selected among n persons.
   Cards in which one person is displayed to determine how close the person is to the user.
To acquire unknown persons close in familiarity distance to a user and who know the user well.
   Cards asking a person if he or she knows the user.
      FIG. 14 shows examples of these cards.

Another pattern is to recommend content.
Cards related to entities other than people (blogs, papers, general news).
Card recommendations unrelated to the user.
   Cards for evaluating randomly selected content.
   Cards for evaluating newly created content.
   Cards for evaluating content related to “hot” topics.
Card recommendations related to the user.
   Cards for evaluating content with high similarity to the user.
   Cards for evaluating content rated highly by users with a high similarity to the user.
   Cards for evaluating content estimated to be of value to the user using methods such as collaborative filtering.
   Cards for evaluating content related to pages in the user's history when the web page browsing history of the user can be obtained.
      Instead of a “card evaluating content” a card can be presented which shows only some of the content. Here, whether or not “Read more” has been clicked is also tracked. Depiction of these cards has been omitted.

The examples explained above were constructed as a Java®-based client-server system. However, the present invention is not restricted to a particular platform and can be realized using any hardware, operating system, programming processing system, or network environment. The depicted cards are merely examples and it should be understood that any card getting the attention of a user or prompting a user to input information is within the scope of the present invention.

We claim:

1. A computer implemented method for expanding a social graph, wherein the computer comprises a processor communicatively coupled to a memory, the method comprising the steps of:
preparing a plurality of questions for adding to the social graph an edge E1 or an edge E1 and a node N1 at an endpoint of the edge;
determining a predetermined number of questions among the plurality of prepared questions to present to a user indicated by given node N2 representing a user in the social graph; and
the determination step comprising a step performed based on at least one item among operating costs for an operation in an answer to a question, the distance between node N2 and node N3 at one endpoint of the added edge E1, and the sum of the inter-nodal distances reduced by the addition of edge E1 across some or all of the nodes in the social graph.

2. The computer implemented method according to claim 1, wherein the determination is performed based on a priority calculated using (sum of distances shrunk by introduction of edge)/[(distance between N2 and N3+1)*(operating costs)].

3. The computer implemented method according to claim 1, wherein at least one question among the plurality of questions prompts the user to enter at least one tag being a keyword related to the user and the tag is associated with the user and stored.

4. The computer implemented method according to claim 3, wherein at least one question among the plurality of questions displays the tag having been entered previously.

5. The computer implemented method according to claim 1, wherein each step is implemented on a web server and the user of the social graph corresponds to a user terminal connected to the web server.

6. The computer implemented method according to claim 5, wherein the questions are displayed on the user terminal in card format.

7. The computer implemented method according to claim 6, wherein a web browser is installed on the user terminal and the questions are displayed in the web browser in card format.

8. A computer readable storage medium tangibly embodying a computer readable non-transitory program code having computer readable instructions which, when implemented, cause a computer to carry out the steps of a method for expanding a social graph, the method comprising the steps of:
preparing a plurality of questions for adding to the social graph an edge E1 or an edge E1 and a node N1 at an endpoint of the edge;
determining a predetermined number of questions among the plurality of prepared questions to present to a user indicated by given node N2 representing a user in the social graph; and
the determination step including a step performed based on at least one item among operating costs for an operation in an answer to a question, the distance between node N2 and node N3 at one endpoint of the added edge E1, and the sum of the inter-nodal distances reduced by the addition of edge E1 across some or all of the nodes in the social graph.

9. The computer readable storage medium according to claim 8, wherein the determination is performed based on a priority calculated using (sum of distances shrunk by introduction of edge)/[(distance between N2 and N3+1)*(operating costs)].

10. The computer readable storage medium according to claim 8, wherein at least one question among the plurality of questions prompts the user to enter at least one tag being a keyword related to the user and the tag is associated with the user and stored.

11. The computer readable storage medium according to claim 10, wherein at least one question among the plurality of questions displays the tag having been entered previously.

12. The computer readable storage medium according to claim 8, wherein each step is implemented on a web server and the user of the social graph corresponds to a user terminal connected to the web server.

13. The computer readable storage medium according to claim 12, wherein the questions are displayed on the user terminal in card format.

14. The computer readable storage medium according to claim 13, wherein a web browser is installed on the user terminal and the questions are displayed in the web browser in card format.

15. A computer system for expanding a social graph, comprising:
means for preparing a plurality of questions for adding to the social graph an edge E1, or an edge E1 and a node N1 at an endpoint of the edge;
means for determining a predetermined number of questions among the plurality of prepared questions to present to a user indicated by given node N2 representing a user in the social graph; and
the means for determining including means performed based on at least one item among operating costs for an operation in an answer to a question, the distance between node N2 and node N3 at one endpoint of the added edge E1, and the sum of the inter-nodal distances reduced by the addition of edge E1 across some or all of the nodes in the social graph.

16. The computer system according to claim 15, wherein at least one question among the plurality of questions prompts the user to enter at least one tag being a keyword related to the user and the tag is associated with the user and stored.

17. The computer system according to claim 16, wherein at least one question among the plurality of questions displays the tag having been entered previously.

18. The computer system according to claim 15, wherein the system is a web server and the user of the social graph corresponds to a user terminal connected to the web server.

19. The computer system according to claim 18, wherein the questions are displayed on the user terminal in card format.

20. The computer system according to claim 19, wherein a web browser is installed on the user terminal and the questions are displayed in the web browser in card format.
